(19) United States
(12) Patent Application Publication
(10) Pub. No.: US 2021/0047202 A1
(43) Pub. Date: Feb. 18, 2021

(54) A WATER RECIRCULATION DEVICE ALLOWING FOR PURIFICATION AND RECYCLING OF WATER OR MULTIPLE SEPARATION

(71) Applicant: ORBITAL SYSTEMS AB, MALMÖ (SE)

(72) Inventor: Michael RIDELL, STAFFANSTORP (SE)

(21) Appl. No.: 16/964,447

(22) PCT Filed: Feb. 8, 2019
(86) PCT No.: PCT/SE2019/050106

§ 371 Date: Jul. 23, 2020

(30) Foreign Application Priority Data
Feb. 23, 2018 (SE) 1850205-4

(51) Int. Cl. C02F 1/00; C02F 1/32; E03B 1/04

(52) U.S. Cl. CPC C02F 1/008; C02F 1/325; C02F 2103/002; E03B 1/041; C02F 1/001

(57) ABSTRACT

The present invention describes a system comprising a water recirculation device 1 allowing for purification and recycling of water or separation of water, said water recirculation device 1 comprising a water treatment unit 2 and a sensor system 3 arranged for measurement of at least water quality and which sensor system 3 is connected to a control unit, and wherein the system also comprises at least two separation points, wherein one first separation point 30 is positioned within the water recirculation device 1 to allow for recirculation of clean water or separation of a first separated stream of water not intended to be recirculated in the water recirculation device 1, and wherein one second separation point 30 is arranged for separation of the first separated stream of water in at least one high quality water stream and in one low quality water stream, and wherein a decision of recirculation or separation is made by the control unit based on the measurement of water quality.

### FIELD OF THE INVENTION

The present invention relates to a system comprising a water recirculation device allowing for purification and recycling of water or separation of water, wherein the separation of water is a multiple separation of water.

### TECHNICAL BACKGROUND

There are existing known water recirculation systems. The water recirculation systems of interest in relation to the present invention are those measuring water quality known and using this data information as a basis for a decision if to recirculate or discard the water given the specific water quality at that specific time. One example is disclosed in WO2013/095278, which describes a hybrid device for a recirculation shower allowing purification and either recycling of water or discarding of water. The hybrid device comprises a water quality sensor which measures the water quality, and said water quality sensor may be a TOC sensor (Total Organic Carbon), a biosensor, a pH meter (measuring acidity or alkalinity) or an optical sensor. Furthermore, in WO 2015/094107 there is disclosed a hybrid device allowing purification and either recycling of water or discarding of water, where said hybrid device comprises a recirculation loop, a filter system and multiple sensors which are conductivity sensors.

One aim of the present invention is to provide an optimal water recirculation system allowing for water quality measurement to drive a decision if to recirculate or separate off water, where the recirculation system provides increased total water recovery.

### SUMMARY OF THE INVENTION

The latter stated purpose above is achieved by a system comprising a water recirculation device allowing for purification and recycling of water or separation of water, said water recirculation device comprising a water treatment unit and a sensor system arranged for measurement of at least water quality and which sensor system is connected to a control unit, and wherein the system also comprises at least two separation points, wherein one first separation point is positioned within the water recirculation device to allow for recirculation of clean water or separation of a first separated stream of water not intended to be recirculated in the water recirculation device, and wherein one second separation point is arranged for separation of the first separated stream of water in at least one high quality water stream and in one low quality water stream, and wherein a decision of recirculation or separation is made by the control unit based on the measurement of water quality.

It should be mentioned that the water recirculation device according to the present invention may comprise several different units and components not mentioned above. Moreover, both the water treatment unit and the sensor system, respectively, may comprise several different components. This is further described below.

Furthermore, the two separation points may be located in two different locations but may also be arranged in one and the same point. According to the latter case, the present invention is also directed to a system comprising a water recirculation device allowing for purification and recycling of water or separation of water, said water recirculation device comprising a water treatment unit and a sensor system arranged for measurement of at least water quality and which sensor system is connected to a control unit, and wherein the system also comprises a separation point within the water recirculation device to allow for recirculation of clean water or separation of at least two separated streams of water not intended to be recirculated in the water recirculation device, wherein the at least two separated streams of water differ in water quality, and wherein a decision of recirculation or separation is made by the control unit based on the measurement of water quality. In this case, it is actually only one separation point arranged in the system, however in this point at least two streams may be separated off, which streams differ in terms of water quality.

According to the present invention, different water quality fractions may be separated off so that the total water recovery may be maximised. To give one example, in a recirculation shower according to the present invention, high quality water may be recirculated in the shower, a comparatively medium water quality fraction may be separated off and then flowed to and used in a washing machine or for flushing in a toilet or in a grey water usage, and a lower water quality fraction may be sent to waste. The present invention also enables to fractionate the water in several different water quality fractions for multiple usage.

### BRIEF DESCRIPTION OF THE DRAWINGS

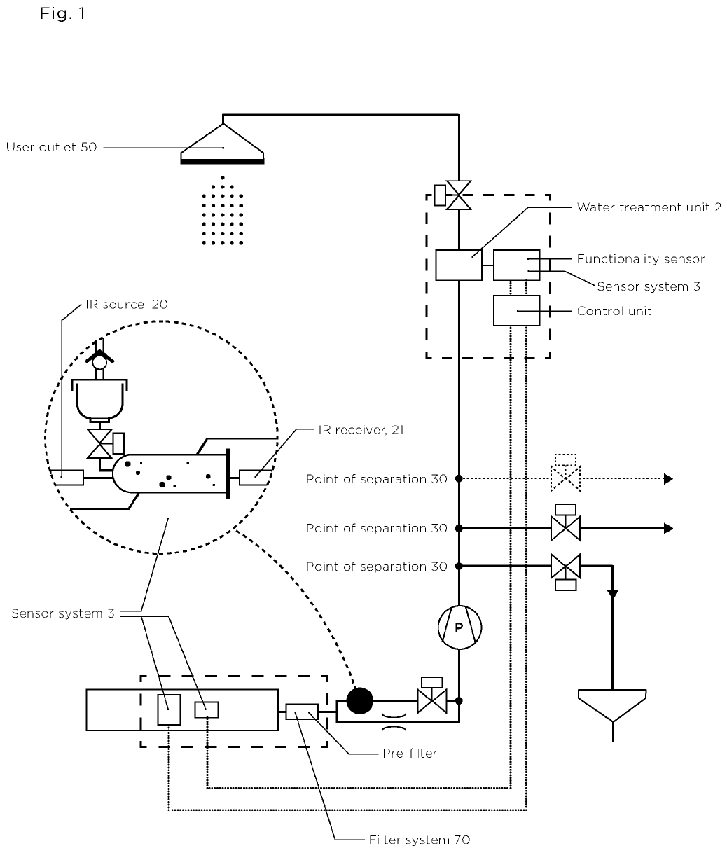

In FIG. 1 there is shown one embodiment of the present invention.

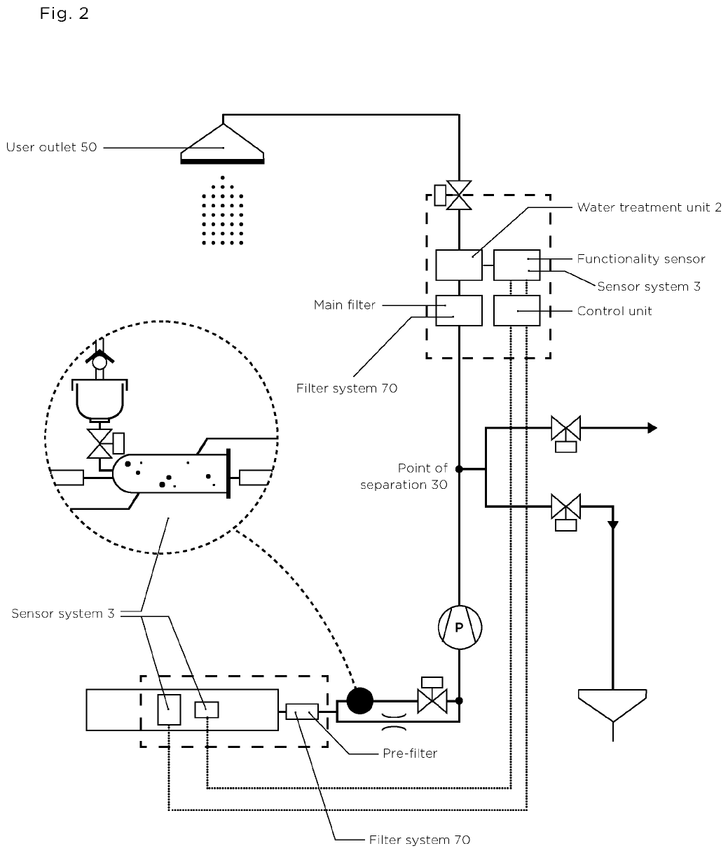

In FIG. 2 there is shown yet another embodiment of the present invention.

### SPECIFIC EMBODIMENTS OF THE INVENTION

Below, specific embodiments of the present invention are disclosed. According to one embodiment of the present invention, the system is arranged to recirculate clean water to another system or in the water recirculation device itself. This implies that recirculation of water also may be performed not only in the device itself but also directly to another device. It should of course be mentioned that this also implies that recirculation may involve both recirculation directly I the device, such as for instance in a shower to reuse clean water, but may also involve recirculation to another device, such as a washing machine or the like, either directly or subsequent to a water quality measurement or water treatment.

Furthermore, another possible example according to the present invention involves a first unit using water. The used water is then sent to a water reservoir in the system, where water quality is measured, either before or subsequent to a water treatment. If the water quality is high enough, then it is flown back to the first unit or to another unit. If the water quality is of a medium level, it may be used in a different application, such as in a washing machine or for irrigation or the like. Furthermore, when the water quality is so low so that fraction cannot be used anymore, then this water is flown to waste.

Based on the above it should be understood that the present invention also embodies a system being arranged so that separated water is collected in another unit or system.

The present invention is directed to increased total recovery of water by using the water in different quality fractions for suitable applications. The water fractions may be used directly after separation, such as for flushing a toilet or in irrigation, or may be fractionated even further to increase the quality of a certain stream by separating off contaminants. As such, a stream may increase in water quality after separation by separating off contaminants. Such a stream may then be sent back to a use intended for high water quality.

Besides the separation point(s) and possible water treatment unit(s) in a system according to the present invention, also the sensor system is of great importance. Water quality measurement is important to be able to set the water quality level for different streams at different points in the recirculation system to drive the separation as intended. In relation to the sensor system it should be noted that the sensor system may comprise only one sensor or several sensors. If several sensors are provided, these may be of one type or different types. The sensor system, regardless of comprising one or more sensors, is connected to a data collecting unit, such as a control unit or the like. Moreover, the sensor system may have one or several purposes, such as discussed more below. One purpose is of course directed to measurement of water quality. Another additional possible purpose may be to measure or indicate the functionality of a unit in the water recirculation device.

The sensor system may comprise several sensors, and also sensors of different type. According to one specific embodiment of the present invention, the sensor system comprises any of a turbidity sensor, a conductivity sensor or a light sensor, or any combination thereof, as a water quality sensor. In the case of a turbidity sensor, a light source may be provided and the turbidity sensor then measures the level of light penetrating the water. Such a measurement may be performed in a tube before a point of separation where the water either may be recirculated or separated off. Also another type of light sensor may be used, which then measures different wavelength ranges, such as UV or IR or the like. This is further discussed below. As notable from above, also one or more conductivity sensors may be used for measuring the conductivity which also may be used as a water quality indicator.

According to yet another embodiment of the present invention, then the system comprises a IR source and IR sensor (IR receiver). Generally, IR is said to have a wavelength range of from 700 nm to 1 mm, i.e. just above the visible light. According to one specific embodiment of the present invention, the sensor system is directed to the area called NIR (near-infrared), with a wavelength area normally defined in the range of from 750 nm to 1.4 μm. Therefore, according to one specific embodiment of the present invention, the IR source and IR receiver are a NIR source and NIR receiver, respectively. According to yet another specific embodiment of the present invention, the wavelengths used in the IR source is in the whole range of from 700 nm to 1.7 μm. According to yet another specific embodiment, the wavelengths used in the IR/NIR source is from 900 nm to 1.2 μm.

It should be mentioned that also other light sensors may be used, such as one or more UV sensors. Moreover, different wavelengths may be combined, both in terms of light sources and light sensors, e.g. UV and IR (NIR). Furthermore, these may be used alone or be combined with other types of sensors, such as turbidity sensor(s) and/or electric conductivity (EC) sensor(s).

It should also be noted that the water treatment unit may be a UV light unit. Therefore, another possible sensor used may be a UV sensor which is intended to measure if the UV light unit is working as intended. Based on the above, according to one specific embodiment of the present invention, the water recirculation device comprises a functionality sensor for the water treatment unit. This may not only be a UV sensor, but can also be another type based on the water treatment unit incorporated in the system. Nevertheless, according to one specific embodiment of the present invention, the water treatment unit is a UV light and the functionality sensor is a UV sensor.

Also other types of sensors are possible. According to one specific embodiment of the present invention, the sensor system comprises a micro-spectrometer, an energy sensor and/or a camera module and an image sensor. The sensor system may comprise a micro-spectrometer, e.g. in the form of a NIR-UV-micro-spectrometer. There are many different types of micro-spectrometers available on the market today, intended for different types of wavelengths ranges. Furthermore, the sensor system may comprise a camera module and an image sensor. This camera module and image sensor may be intended for the detection of particles, e.g. as a particle counter. The camera module sends a flash light into a transparent measurement space and the image sensor then takes an image when the space is illuminated. For particle counting or the like there are software possible to use when doing calculations from the image data sent from the image sensor to a control unit or computer unit.

According to one specific embodiment of the present invention, the IR source and the IR receiver are positioned on each sides of a transparent portion of a flow path for recycled water and before the point of separation. This transparent portion is also suitable to include when a camera module and an image sensor are implemented in a system according to the present invention.

Furthermore, according to yet another embodiment of the present invention, the device comprises an off-line loop arrangement which comprises a liquid-stagnant space, intended for water quality measurement. In such a case a IR source and a IR sensor (receiver) may be arranged to perform the measurement in the liquid-stagnant space. The off-line loop arrangement may e.g. be in the form of a transparent glass tube. The off-line loop arrangement is of interest to ensure that the water sample being measured is arranged in a liquid-stagnant space. At the moment, a IR measurement sequence or sweep over for instance a wavelength range of 700-1000 nm needs around 1 second to be performed. This further implies that at the moment with reference to the general IR and NIR technology development it is of interest to ensure to perform the IR or NIR water quality measurement in a space where the water is stagnant as it is not suitable to perform in flowing water.

Moreover, the loop arrangement according to the present invention may have different type of design and arrangement. According to one specific embodiment the loop arrangement is driven by use of throttling design and possibly also an arranged ejector pump which has a sucking effect for filling up the loop arrangement with a new water sample to measure. With this type of arrangement, e.g. an enzyme or the like may also be sucked into the loop arrangement by use of the ejector pump.

The device according to the present invention may of course also comprise other units. According to one specific embodiment of the present invention, the device also comprises a user outlet, a heater and a filter system. The user outlet differs depending on the type of device. To give some examples it may be a shower head in a shower device, or other types of nozzles, e.g. in a hair shower, or outlets in a washing machine or dishwasher. The heater may any type suitable for heating the water flow, however for instance a combined UV unit and heater for water treatment may be one possible alternative according to the present invention.

Regarding the filter system, this may comprise one or several units. According to one specific embodiment, then the filter system only comprises a rough filter, which is intended to collect larger particles or the like, e.g. hair and so in a shower device. Such a rough filter may e.g. be positioned in the drain of a device according to the present invention. According to another specific embodiment of the present invention, then the filter system comprises also a finer filter, such as a micro-filter, which is intended to collect much smaller particles in the water flow.

Moreover, the present invention also provides a method for separating water fractions in a water recirculation device allowing for purification and recycling of water or separation of water, said water recirculation device comprising a water treatment unit and a sensor system arranged for measurement of at least water quality and which sensor system is connected to a control unit, said method comprising passing a water flow through at least two separation points, wherein one first separation point is positioned within the water recirculation device allowing for recirculation of clean water or separation of a first separated stream of water not intended to be recirculated in the water recirculation device, and wherein one second separation point is arranged for separation of the first separated stream of water in at least one high quality water stream and in one low quality water stream, and wherein a decision of recirculation or separation is performed by the control unit based on the measurement of water quality.

In the case above, two points of separation are arranged. As mentioned, the present invention also embodies the case where the separation points are provided in one and the same point. As such, the present invention also embodies multiple water separation in one and the same separation point. Therefore, according to one specific embodiment of the present invention, there is provided a method for separating water fractions in a water recirculation device allowing for purification and recycling of water or separation of water, said water recirculation device comprising a water treatment unit and a sensor system arranged for measurement of at least water quality and which sensor system is connected to a control unit, said method comprising passing a water flow through a separation point within the water recirculation device to allow for recirculation of clean water or separation of at least two separated streams of water not intended to be recirculated in the water recirculation device, wherein the at least two separated streams of water differ in water quality, and wherein a decision of recirculation or separation is performed de by the control unit based on the measurement of water quality.

### DETAILED DESCRIPTION OF THE DRAWINGS

In FIG. 1 there is shown one specific embodiment according to the present invention. The system comprises a water recirculation device 1, in this case a shower, allowing for purification and recycling of water or separation of water, comprising a water treatment unit 2 and a sensor system 3 arranged for measurement of at least water quality. The system also comprises at least two separation points 30 or on separation point 30 from which two different water quality stream are separated. In this case three separation points 30 are shown.

The first point of separation 30 is provided so that low quality water or contaminated water may be sent to waste (to a waste drain). If the quality of the water is high enough, then the flow is recirculated and sent further in the flow path 4. A second point of separation 30 may be arranged so that a higher quality water fraction may be sent to a recovery and second usage of that water fraction, such as in a washing machine, for irrigation purposes, or for flushing in a toilet. Furthermore, if the water quality is even higher than, water may be recirculated further in the flow path 4, either passing another point of separation 30, shown in FIG. 1, for another type of application or totally recycled in the water recirculation device 1. As shown in FIG. 1, the water recirculation device 1 is a shower, and the water fraction having a quality high enough for reuse in the shower is totally recycled in the shower. Moreover, it is important to understand that also part of a flow may be separated off in different points of separations 30. Another way to describe the above possibility is that the present invention enables to separate suitable fractions as high quality water, another fraction for grey water use and also low quality water to intended waste.

Furthermore, in this specific embodiment the device 1 also comprises a user outlet 50, in this case a shower nozzle as the device 1 is a recirculation shower. It is important to understand that many other industrial applications are possible according to the present invention, such as washing machines, dishwashers, hair showers etc. where the recirculation of water may be of interest.

Moreover, the water recirculation device 1 also comprises a sensor system 3 for measurement of water quality. Said sensor system 3 may comprise at least a IR source 20 and a IR receiver 21. Furthermore, as shown in FIG. 1, according to this embodiment the IR/NIR source 20 and receiver 21 are positioned in an off-line loop arrangement 40. A throttling on the main tube of the flow path 4 enables water to be sucked into the off-line loop 40. This arrangement enables to measure a water volume which is not in movement. Moreover, and as shown in the enlargement of the black circle, the measurement portion may also comprise an addition unit enabling adding other substances, such as an enzyme or cleaning agents etc. Valves are provided at suitable positions for the processing of the system. Furthermore, a pump is used to enable recirculation in the system. Moreover, also an ejector pump may be provided to enable water to be flown into the off-line loop arrangement 40.

The senor system 3 may also comprise other components, such as electrical conductivity (EC) sensor(s) and a turbidity sensor, which in this embodiment are arranged in a water receiving unit (shower drain) in the shower. Moreover, the sensor system 3 according to the present invention may also comprise other types of sensors or units. Examples are a UV sensor for also detecting UV light and not only IR or NIR, an energy sensor, a micro-spectrometer, and/or a camera module with an image sensor. Moreover, the water treatment unit 3 may be in the form of a UV light and/or heater, also a combined UV and heater. As such, the sensor system 3 may also comprise a functionality sensor for the UV light. Furthermore, the sensor system 3 is connected to a control unit which decides if water should be recycled or discarded in the point of separation(s) 30 based on the measurement of the water quality.

Furthermore, according to this embodiment the water recirculation device 1 also comprises a filter system 70 which in this case only contains a rough filter (in this case called pre-filter), intended to filter off large particles or hair or the like.

In FIG. 2 there is shown yet another embodiment of the present invention. In this case only one point of separation 30 is provided, however as notable two separate streams are separated off in this point of separation 30. In this example, water of very high quality is recirculated in the device 1. Water of medium quality is separated in the point of separation 30 and for example sent to a second use, such as in a washing machine, for toilet flushing or in irrigation purposes. Water of really low quality may instead be sent to waste. The water quality measurement may send a signal to a control unit to decide if water should be recirculated, separated off for subsequent usage or sent to waste.

Furthermore, the device 1, also in the form of a shower, comprises a first shower drain unit. In this drain unit two sensors are provided which are also part of the sensor system 3. In this case, these sensors may be a level sensor and a water quality sensor, such as e.g. a turbidity sensor or the like. This embodiment is very similar to the embodiment shown in FIG. 1, however in this case the system also comprises a filter system 70 comprising both a pre-filter being a rough filter and also a main filter which is intended to filter off smaller particles, e.g. of micro-size or even smaller. It should be noted that the filter system 70 may also only comprise only one filter such as according to FIG. 1. Moreover, the filter system 70 is of course totally optional.

1. System comprising a water recirculation device allowing for purification and recycling of water or separation of water, said water recirculation device
comprising a water treatment unit and a sensor system arranged for measurement of at least water quality and which sensor system is connected to a control unit,
and wherein the system also comprises at least two separation points, wherein one first separation point is positioned within the water recirculation device to allow for recirculation of clean water or separation of a first separated stream of water not intended to be recirculated in the water recirculation device, and wherein one second separation point is arranged for separation of the first separated stream of water in at least one high quality water stream and in one low quality water stream, and wherein a decision of recirculation or separation is made by the control unit based on the measurement of water quality.

2. System comprising a water recirculation device allowing for purification and recycling of water or separation of water, said water recirculation device comprising a water treatment unit and a sensor system arranged for measurement of at least water quality and which sensor system is connected to a control unit,
and wherein the system also comprises a separation point within the water recirculation device to allow for recirculation of clean water or separation of at least two separated streams of water not intended to be recirculated in the water recirculation device, wherein the at least two separated streams of water differ in water quality, and wherein a decision of recirculation or separation is made by the control unit based on the measurement of water quality.

3. System according to claim 1, wherein the system is arranged to recirculate clean water to another system or in the water recirculation device itself.

4. System according to claim 1, wherein the system is arranged so that separated water is collected in another unit or system.

5. System according to claim 1, wherein the sensor system comprises any of a turbidity sensor, a conductivity sensor or a light sensor, or any combination thereof, as a water quality sensor.

6. System according to claim 1, wherein the sensor system comprises a IR source and IR sensor.

7. System according to claim 1, wherein the water recirculation device comprises a functionality sensor for the water treatment unit.

8. System according to claim 7, wherein the water treatment unit is a UV light and the functionality sensor is a UV sensor.

9. System according to claim 1, wherein the sensor system comprises a micro-spectrometer, an energy sensor and/or a camera module and an image sensor.

10. System according to claim 1, wherein the system also comprises an off-line loop arrangement which comprises a liquid-stagnant space, intended for water measurement.

11. System according to claim 10, wherein a IR source and IR receiver are arranged to perform the measurement in the liquid-stagnant space.

12. Method for separating water fractions in a water recirculation device allowing for purification and recycling of water or separation of water, said water recirculation device comprising a water treatment unit and a sensor system arranged for measurement of at least water quality and which sensor system is connected to a control unit,
said method comprising passing a water flow through at least two separation points, wherein one first separation point is positioned within the water recirculation device allowing for recirculation of clean water or separation of a first separated stream of water not intended to be recirculated in the water recirculation device, and wherein one second separation point is arranged for separation of the first separated stream of water in at least one high quality water stream and in one low quality water stream, and wherein a decision of recirculation or separation is performed by the control unit based on the measurement of water quality.

13. Method for separating water fractions in a water recirculation device allowing for purification and recycling of water or separation of water, said water recirculation device comprising a water treatment unit and a sensor system arranged for measurement of at least water quality and which sensor system is connected to a control unit,
said method comprising passing a water flow through a separation point within the water recirculation device to allow for recirculation of clean water or separation of at least two separated streams of water not intended to be recirculated in the water recirculation device, wherein the at least two separated streams of water differ in water quality, and wherein a decision of recirculation or separation is performed de by the control unit based on the measurement of water quality.
